(19) United States
(12) Patent Application Publication
(10) Pub. No.: US 2014/0123043 A1
(43) Pub. Date: May 1, 2014

(54) Selecting Devices for Data Transactions

(71) Applicant: INTEL MOBILE COMMUNICATIONS GMBH, Neubiberg (DE)

(72) Inventors: Andreas Schmidt, Braunschweig (DE); Maik Bienas, Braunschweig (DE); Martin Hans, Bad Salzdetfurth (DE)

(73) Assignee: INTEL MOBILE COMMUNICATIONS GMBH, Neubiberg (DE)

(21) Appl. No.: 13/664,590

(22) Filed: Oct. 31, 2012

(51) Int. Cl. G06F 3/048; G06F 3/041

(52) U.S. Cl. 715/769

(57) ABSTRACT

Examples of a user interface are described that may include a graphical representation of computing devices in the same network or area as a first computing device. A user may drag his or her finger (slide gesture) between the representations of the computing devices in order to perform data transactions between the computing devices without having to monitor those other computing devices. The locations of the computing devices may be intermittently updated on the user interface. Also, the speed of the slide gesture may determine the data transaction that is to be performed.

### BACKGROUND

Transferring files between folders or file libraries through a visual user interface is commonplace on computing devices. As home and office networks become more complex and incorporate more computing devices with more capabilities, the ability to perform data transactions between these devices in a convenient and efficient manner is needed. Moreover, wireless mobile piconet use is becoming more widespread, in which various mobile devices may dynamically enter and leave a relatively small wireless network depending at least in part upon their physical proximities to one another. Such piconets often occur in, for instance, business settings such as meetings and conferences. It may be desirable to be able to use device locations as at least one factor in interacting with devices in such piconets or other types of dynamic and temporary networks.

### SUMMARY

A convenient way may be provided to select one or more devices, from a plurality of devices in the vicinity for communication (for instance, in a piconet scenario). To accomplish this, a graphical user interface, which may be touch-based may be provided on one or more of the devices. Various user gestures (e.g., touch screen gestures) may be used to select a target peer device for wireless communication and/or to select a data transaction to be performed with the target device. For example, the address or other identity of a target device, the type of data transaction to be performed, and/or selected data items involved in the data transaction, may be determined by one or more gestures (e.g., finger movements) on the touch screen of another device. These factors may be determined by, for example, the length of the gesture (e.g., a sliding, or dragging, gesture); the direction of the gesture's movement, such as by determining the angle(s) between the finger's (or other pointer's) approximate line of movement and at least one reference line); the speed of the gesture; the number of fingers or other pointers used for the gesture; one or more attributes of a (virtual) line displayed on the touch screen of the user interface (e.g., continuous or dotted/dashed line); and/or the position where the gesture movement begins and/or ends.

Accordingly, some aspects as disclosed herein are directed to, for example, a method, system, apparatus, and/or software for performing at least the following: displaying on a user interface representations of multiple computing devices between which a user may perform data transactions. In some aspects of the disclosure, the distances between the computing devices may be to scale and updated intermittently on the user interface. A user may initiate a data transaction between two computing devices by dragging his or her finger on a touch screen of a user interface from one representation of a computing device to another.

Further aspects as described herein are directed to using the speed of a user input, such as but not limited to a slide gesture. The speed of the user input (e.g., the speed of a user's finger or other physical or virtual pointer dragging across a graphical user interface) may be used as a relevant input to a data transaction selection. For example, the particular data transaction that is to occur may be determined by the speed of the slide gesture or other user input. For example, a relatively fast user input (e.g., slide gesture) may initiate a first type of data transaction (e.g., the sending of a text message), while a relatively slower user input (e.g., slide gesture) may initiate a second type of data transaction (e.g., the sending of an email).

Still further aspects as described herein are directed to prioritizing the performance of two or more simultaneous (parallel) data transactions between two or more computing devices. For instance, a user may perform two parallel data transactions by dragging his or her finger from a first computing device icon to a second computing device icon and then dragging his or her finger from a third computing device icon to a fourth computing device icon. In some of those aspects, the relative speeds of the two slide gestures or other user inputs may determine the relative priority of the two data transactions to be performed.

In still further aspects as described herein, the user interface may display an indication of one or more transfer regions extending from or near an icon representing a first computing device to or toward an icon representing a second computing device. The user may, for example, drag his or her finger inside the transfer region from a position at or near a representation of a first computing device to a position at or near a representation of a second computing device in order to perform a specified data transaction between the two computing devices.

Still further aspects may also involve one or more multiple transfer regions of the user interface. For instance, the sizes (e.g., widths) of the transfer regions may depend upon how many transfer regions are in the user interface and/or how close together the transfer regions are to each other in the user interface. As another example, the transfer regions may overlap in one or more locations, resulting in the opportunity to perform data transactions simultaneously between multiple computing devices.

The preceding presents a simplified summary in order to provide a basic understanding of some aspects of the disclosure. The summary is not an extensive overview of the disclosure. It is neither intended to identify key or critical elements of the disclosure nor to delineate the scope of the disclosure. The summary merely presents some concepts of the disclosure in a simplified form as a prelude to the description below.

### BRIEF DESCRIPTION OF THE DRAWINGS

A more complete understanding of the present disclosure and the potential advantages of various aspects described herein may be acquired by referring to the following description in consideration of the accompanying drawings, in which like reference numbers indicate like features, and wherein:

FIG. 1 is a block diagram of an example computing device that may embody or implement one or more elements or functions as described herein;

FIG. 2 is a block diagram of an example system that may include a plurality of computing devices that may communicate with each other;

FIG. 3 is an example user interface displaying representations of computing devices.

FIG. 4 is an example user interface displaying a data transaction between a first computing device and a third computing device.

FIG. 5 is another example user interface displaying data transactions between multiple computing devices.

FIG. 6 is an example user interface displaying a media library of one computing device from which a user may select files and transfer them to another computing device.

FIG. 7 is another example user interface displaying a media library from which a user may select multiple files to transfer between computing devices.

FIG. 8 is an example user interface displaying a pulling of data from a computing device to a first computing device that the user is operating.

FIG. 9 is another example user interface displaying a data transaction between computing devices remote from the first computing device displaying the user interface.

FIG. 10 is an example user interface displaying a transfer region extending from a representation of a first computing device to a representation of a third computing device.

FIG. 11 is another example of a user interface displaying multiple transfer regions extending from a representation of a first computing device to representations of various other computing devices.

FIG. 12 is an example user interface displaying overlapping transfer regions extending from a representation of a first computing device to representations of other computing devices.

It is noted that one or more of the drawings may not necessarily be drawn to scale.

### DETAILED DESCRIPTION

Various example embodiments of a user interface are described herein. The user interfaces may be generated and/or displayed by, e.g., a computing device. A computing device may include any electronic, electro-optical, and/or mechanical device, or system of multiple physically separate such devices, that is able to process and manipulate information, such as in the form of data. Non-limiting examples of a computing device include one or more personal computing devices (e.g., desktop, tablet, or laptop), servers, smart phones, personal digital assistants (PDAs), televisions, monitors, television set top boxes, service gateway devices, digital video recorders, mobile video devices, and/or a system of these in any combination or subcombination. In addition, a given computing device may be physically located completely in one location or may be distributed amongst a plurality of locations (i.e., may implement distributive computing). A computing device may be or include a general-purpose computing device and/or a dedicated computing device configured to perform only certain limited functions. Examples of computing devices include, but are not limited to, desktop computers, laptop computers, tablet computers, “smart” cellular phones, servers, and personal digital assistants. A computing device may be mobile (e.g., portable) or it may be designed to remain in a fixed location.

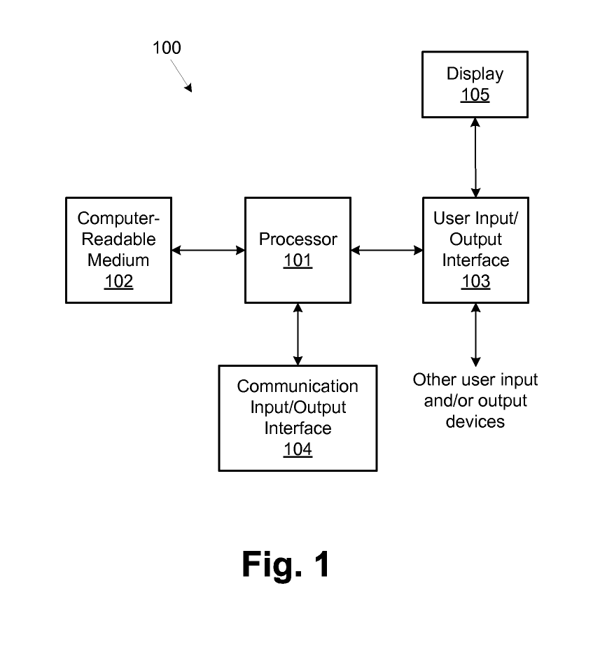

An example block representation of a computing device 100 is shown in FIG. 1. While a particular configuration is shown, it will be understood that a computing device may be configured in other ways. Computing device 100 in this example may include hardware that may execute software to perform specific functions. The software, if any, may be stored by a computer-readable storage device, such as computer-readable storage medium 102, in the form of computer-readable instructions. Computing device 100 may read those computer-readable instructions, and in response perform various steps as defined by those computer-readable instructions. Thus, any functions and operations attributed to a computing device and/or a user interface may be implemented, for example, by a computing device reading and executing such computer-readable instructions for performing those functions, and/or by any hardware subsystem (e.g., a processor 101) from which the computing device 100 is composed. Additionally or alternatively, any of the above-mentioned functions and operations may be implemented by the hardware of computing device 100, with or without the execution of software.

Computer-readable storage medium 102 may include not only a single physical non-transitory storage medium or single type of such storage medium, but also a combination of one or more such storage media and/or types of such storage media. Examples of computer-readable media 102 include, but are not limited to, one or more memories, hard drives, optical discs (such as CDs or DVDs), magnetic discs, and magnetic tape drives. Computer-readable storage medium 102 may be physically part of, or otherwise accessible by, computing device 100, and may store computer-readable data representing computing device-executable instructions (e.g., software) and/or non-executable data.

Computing device 100 may also include a user input/output interface 103 for receiving input (such as gestures) from a user via a user input device (e.g., a keyboard, buttons, a mouse, a joystick, a touch-sensitive display, and/or a remote control) and providing output to the user via a user output device (e.g., a display device 105, an audio speaker, a vibrating tactile output device, and/or a printer). Display device 105 may be any device capable of presenting information for visual consumption by a human, such as a television, a computing device monitor or display, a touch-sensitive display, or a projector. Computing device 100 may further include a communication input/output interface 104 for communicating with devices external to computing device 100, such as with other computing devices and/or other nodes in a network. Communication input/output interface 104 may include, for instance, a wireless communications port for wirelessly sending and/or receiving information through the air, such as via radio frequency and/or infra-red modulated signals. In such a case, the communication input/output interface 104 may include or be coupled to an appropriate antenna, light emitter, and/or light receptor, for performing such wireless communications.

Computing device 100 may be used to generate and/or display one or more user interfaces, such as but not limited to graphical user interfaces. Further, computing device 100 may be connected to other computing devices via the communication input/output interface 104 through a network or other connection, such as the Internet, a cellular network (such as, but not limited to, 3G, 4G, UMTS, or LTE), a Bluetooth connection, and/or an IEEE 802.11 WiFi network.

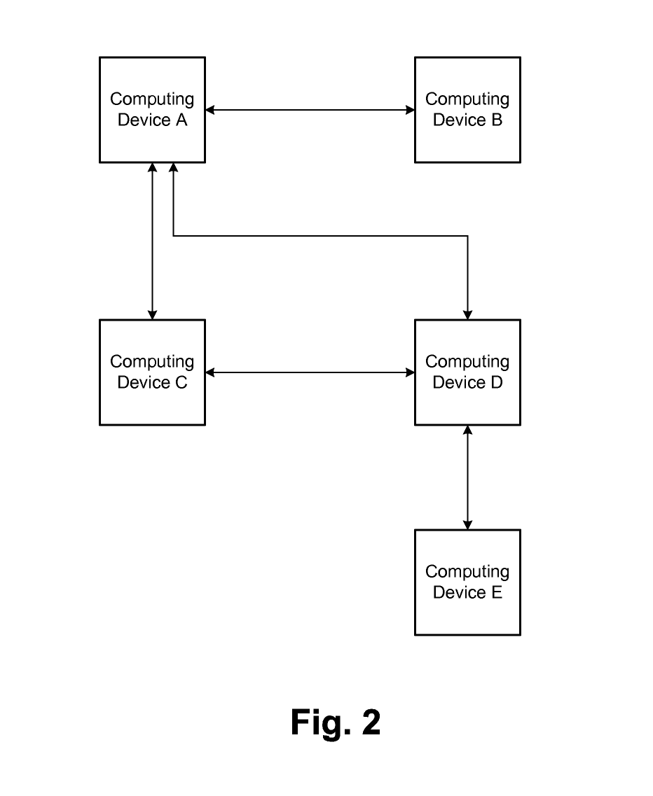

FIG. 2 is a block diagram of an example system and network of computing devices. In this example, there are five computing devices A-E, each of which may be configured, if desired, in the same manner as computing device 100. However, each of computing devices A-E does not need to be the same type of computing device. Also, while five computing devices are shown in FIG. 2, this is merely an example; any number of computing devices may be included in the system. Further, computing devices A-E may or may not support the same communication input/output interface 104 technology. For example, a first subset of the devices A-E may be coupled via a cellular network (such as UMTS or LTE), while a different second subset of the devices A-E may be coupled via short range wireless technology (such as Bluetooth or IEEE 802.11 WiFi). One or more of the devices A-E may belong to both subsets mentioned above and as such be connected to more than one distinct network (e.g., the above-mentioned first and second subsets of devices may or may not overlap).

Arrowed connectors are shown that extend between various example ones of the computing devices A-E. The connectors may represent any type of bi-directional or uni-directional communication path, such as via wireless communication and/or wired communication within a network. Thus, data and/or other signals may travel along such paths between the various computing devices A-E. Also, while particular communication paths are shown between particular ones of the computing devices A-E, it will be understood that this is merely by way of example, and that any of the computing devices A-E may be communicatively coupled to any one or more of the other computing devices A-E as desired. The network of which the communication paths are part of may be any type of wired and/or wireless network, such as but not limited to a piconet (e.g., a BLUETOOTH or wi-fi piconet). The communication paths may be passive or active. That is, each path may be actively passing data between two or more of the computing devices A-E, or may be an established yet currently unused (passive) communication link. For example, computing device A may have previously established/authorized communication with computing devices B, C, and D, but not necessarily with computing device E. In some examples, the network of computing devices A-E may be a mobile wireless network (for instance, a cellular radio communication network) that dynamically changes its membership over time. For example, the various computing devices A-E may be smart phones, tablets, and/or other wireless-capable mobile computing devices. Each of the computing devices A-E may or may not be part of the network at any given time depending upon their current proximity to others of the computing devices A-E. Moreover, one or more of the various computing device A-E may each be simultaneously coupled to more than one communication infrastructure/network. For example, one or more of the various computing devices A-E may be a member of a piconet (such as via Bluetooth or IEEE 802.11 WiFi) and at the same time also have a connection to infrastructure components of a mobile wireless network (such as UMTS or LTE). In such an example, proximity detection between various computing devices may be infrastructure assisted and/or controlled. Thus, the network or other infrastructure used for communicating between devices (e.g., for transferring files and/or for detecting the existence of devices) may be the same or a different network/infrastructure as that used for determining device locations and/or device proximity.

As will be described in detail below, any of the computing devices A-E may be configured to display an interactive user interface to the respective user. The user interface for a given one of the computing devices may include icons or other representations of those of the other computing devices with which the computing device has a communication link (or potential communication link). For example, a user interface displayed by computing device A may include icons for each of the other computing devices B, C, and D, because these are computing devices with which computing device A is already authorized to communicate with. As described above, the ability of the computing devices A-E to communicate with each other may be offered by a variety of communication techniques, including but not limited to cellular radio communication networks (e.g., with base station/infrastructure involvement), and is not limited to short range technologies, such as Bluetooth or IEEE 802.11 WiFi networks. In other examples, the user interface displayed by computing device A may include icons for all of the other computing devices B-E, because each of the computing devices B-E is either a computing device with which computing device A is authorized to communicate, or a computing device that is sensed (e.g., wirelessly) by computing device A to exist and/or to have communication capability. For example, each of computing devices A-E may be located proximate to each other, such as within the same room, the same building, using the same IEEE 802.11 wi-fi network, the same cell of a cellular network, and/or using the same wired local area network. If each of computing devices A-E has BLUETOOTH discovery enabled or is connected to the same local wireless or wired network (for example), then each of the computing devices A-E may detect the presence of each of the other computing devices A-E. In case of a cellular radio communication network, proximity and/or locations of devices may be determined by and/or with the assistance of a base station and/or other infrastructure involvement. For instance, proximity may be determined by the network infrastructure when the computing devices A-E are all camping on the same cell, or are residing in neighboring cells, of a cellular radio communication network.

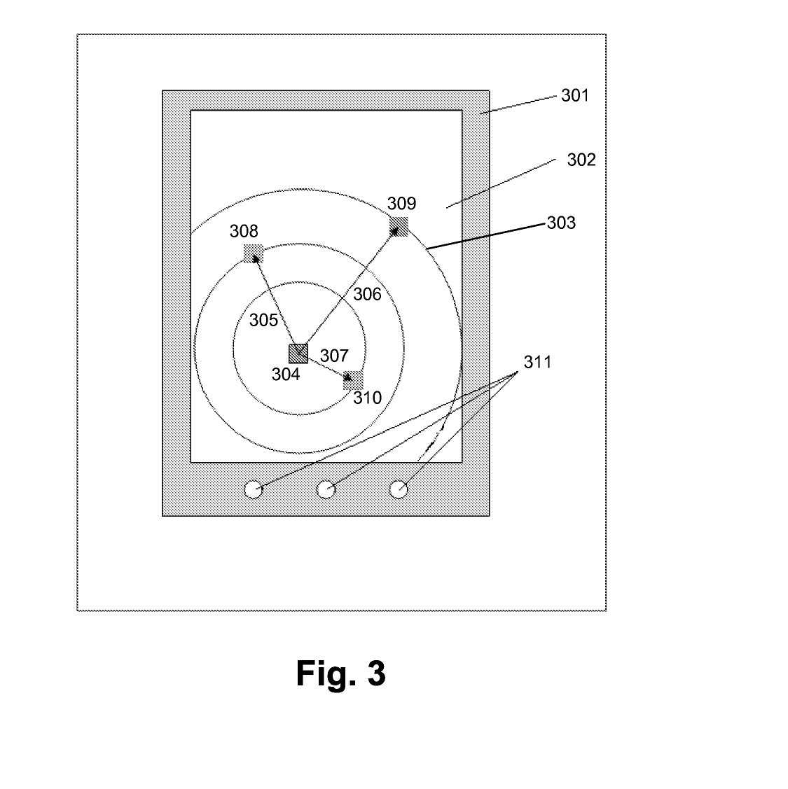

An example of the above-mentioned user interface that may be displayed on one or more of the computing devices is shown in FIG. 3. In this example, a graphical user interface 302 is displayed by a computing device 301, which will also be generically referred to herein as a “first” computing device. First computing device 301 may be implemented, for example, by computing device 100 shown in FIG. 1, in which case the user interface may be displayed on display 105 (which may be implemented as a touch-sensitive display). In this example, we will assume that first computing device 301 is computing device A of FIG. 2. However, first computing device 301 may be any of the computing devices of FIG. 2.

First computing device 301 may be or otherwise include a smart phone, tablet, or other such computing device that further includes soft or hard keys 311 that may perform certain functions related to the operation of first computing device 301. The user interface 302 may include a displayed indication of the location of the first computing device 301, such as in the form of a displayed icon 304 (or other graphical representation) that may lie in a fixed location such as at the center of displayed concentric circles 303 such as shown in FIG. 3. However, the icon 304 of the computing device displaying the user interface 302 may be located anywhere in the user interface 302, and may be presented as a fixed location or a changing location within the user interface 302. A map may or may not also be presented in conjunction with the user interface 302, such that the various icons (e.g., icon 304 may be overlaid on the map). The map and/or the position of the computing device displayed on the map may be intermittently (e.g., periodically) updated to reflect any changes in device position(s), and/or in response to detecting that one or more of the devices has changed position.

The location of the icon 304 within the user interface 302 may depend upon the physical location of the first computing device 301, and/or the icon 304 may be in a fixed position within the user interface 302 regardless of the location of the first computing device 301. The user interface 302 may also display icons or other graphical representations of other computing devices in the vicinity of, sensed by, recognized by, and/or authorized to communicate with, the first computing device 301. The physical locations of these computing devices may be determined and exchanged with the other computing devices through the piconet (or other type of network). For each computing device, such physical location exchange may be performed upon entry to the piconet (or other network) by the computing device and/or updated on an intermittent basis. The physical locations of the various computing devices may be determined through the use of, for instance, any global navigation satellite system (GNSS) positioning techniques such as the global positioning system (GPS), wireless signal triangulation, and/or using other location determining techniques. Thus, the first computing device 301 and/or the other computing devices may include a GPS or other self-position-determination device. These other computing devices may include, by way of example, second, third and fourth computing devices, each represented on the touch screen as icons 308, 309, and 310, or other graphical representations, respectively. The locations of each of the icons 308-310 as displayed within the user interface 302 may depend upon the respective physical locations of each of the second, third, and fourth computing devices, and may or may not be to linear scale with the respective physical locations. The physical locations of each of the second, third, and fourth computing devices may be measured relative to the physical location of the first computing device or they may be measured in an absolute sense. In either case, it may be expected that the direction and/or distance of each of the second, third, and fourth computing devices may be at least partially determined based on the locations of icons 308-310 within the user interface 302.

The process of sensing/recognizing/authorizing other computing devices may be infrastructure assisted (for instance, proximity between the first computing device 301 and other computing devices may be detected using (e.g., with the assistance of) a cellular radio communication network). The right to communicate may be granted after analyzing the subscription data in the core network of the cellular communication network, and information about the physical locations of the respective computing devices may be exchanged using a base station of the cellular communication network.

Any number of computing devices may be simultaneously represented by the user interface. In the shown example, distances between the first computing device and the second computing device, between the first computing device and the third computing device, and between the first computing device and the fourth computing device may be represented as distances indicated in FIG. 3 by element numbers 305, 306, and 307, respectively. These distances may be to scale relative to the actual physical distances between the computing devices, as may be determined by, for example, the GPS devices or other self-position-determination devices. The distances may be linearly or non-linearly related to the actual distances between the respective computing devices. Moreover, the directions of each distance may depend upon the relative directions between the respective computing devices. The distances and/or directions of each distance displayed within the user interface 302 (potentially together with a map) may be updated intermittently (e.g., periodically) and/or in response to detecting that the physical positions of the computing devices has changed.

The first computing device may receive intermittent (e.g., periodic) or continuous updates on the locations of the other computing devices with respect to each other. For instance, each of the computing devices may self-determine its position and report that to the first computing device. Or, the network itself or a third party (e.g., via cell tower triangulation) may determine and/or report the positions. The first computing device may then update the displayed locations of the icons of the computing devices on the screen of the user interface 302. Concentric circles 303 as shown in FIG. 3 may be displayed through each of the icons (radius may equal the distance from the first computing device icon to the respective computing device icon) if desired to allow the user to more easily view the relative distances between the computing devices. As the locations of the various computing devices are updated on the user interface 302, the user of the first computing device may take note of the varying concentric circles 303 and/or displayed radii 305, 306, and 307 to observe the time-varying changes in distances.

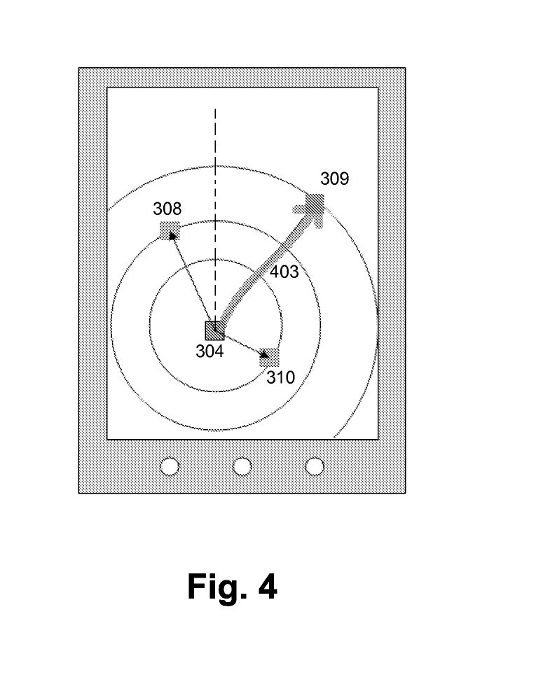

As shown in FIG. 4, a user may elect to perform one or more data transactions between the first computing device (icon 304) and one or more other computing devices such as the third computing device 309. A data transaction may be any type of data transaction between two or more computing devices, such as transferring (e.g., moving or copying) information such as a vCard; text message; email, video, image, audio, or other multimedia file; other type of data file; streaming audio and/or video content; sending electronic money; sending a database query; or initiating a communication such as a telephone call (e.g., a landline and/or cellular call such as by UMTS or LTE), text message, email, or social network interaction. These are just a few examples of the many types of data transactions that may occur.

An example of a data transaction in which a data file is pushed from the first computing device to the third computing device will now be described. To initiate such a data transaction, the user may select a data file and then drag his or her finger on the user interface 302 displayed on the touch-sensitive display of the first computing device from icon 304 to icon 309. Such a dragging-type input is also referred to herein as a slide gesture. In this example, the slide gesture is illustrated in FIG. 4 as slide gesture 403. The slide gesture 403 may include the finger drag movement beginning from or near a starting point (here, icon 304) and ending at or near an end point (here, icon 309). While slide gestures will be described herein with respect to various examples, it will be understood that other types of user input may be used rather than, specifically, slide gestures. For instance, where the speed of a user input is relevant, the user input may include any type of user input that involves moving a physical and/or virtual pointer across a two- or three-dimensional area or space.

The speed of the slide gesture (e.g., the speed at which the user's finger or other pointer slides through the slide gesture) may be used by the first computing device to determine the type of data transaction and/or a property of the data transaction that is to occur between the selected computing devices. For example, the speed of the slide gesture could be used determine whether the data transaction is a file transfer, the streaming of data, the sending of an email, or the sending of a text message.

In a further example, a relatively slow slide gesture may indicate the sending of an email, while a relatively fast slide gesture may indicate the sending of a text message. For instance, if in the above example data transaction, the user were to select a data file and then slide from icon 304 to icon 309 slowly, this may indicate a data transaction to push the data file from the first computing device (the computing device represented by icon 304) to the third computing device (the computing device represented by icon 309). If, however, the same data file is selected, the data file is a multimedia file, and the slide gesture is a faster slide gesture (e.g., comparing the speed of the slide gesture with a predetermined threshold speed, and the speed of the slide gesture is faster than, or greater than or equal to, the predetermined threshold speed), then this gesture may be interpreted as a request to initiate live streaming of the data file from the first computing device to the third computing device. Thus, more generically, a slide gesture having a slow slide speed may invoke a first type of data transaction, whereas that same slide gesture having a faster slide speed may invoke a different second type of data transaction. The first computing device may determine whether the slide gesture is a slow slide gesture or a fast slide gesture by, for instance, comparing the speed of the slide gesture with a predetermined threshold speed.

If the comparison results in a determination that the speed of the slide gesture is less than (or, alternatively, less than or equal to) the threshold speed, then the first computing device may consider the slide gesture to be a slow slide gesture. If the comparison results in a determination that the speed of the slide gesture is greater than (or, alternatively, greater than or equal to) the threshold speed, then the first computing device may consider the slide gesture to be a fast slide gesture. There may be multiple predetermined thresholds or ranges of speed, corresponding to three or more different determined speeds of the slide gesture. For instance, the slide gesture may be determined to be either a slow slide gesture, a medium speed slide gesture, or a fast slide gesture, each speed potentially being associated with a different data transaction.

In addition to the speed of a slide gesture or other gesture indicating the type of data transaction to be performed, the speed may be used to indicate one or more characteristics of a data transaction to be performed. For example, a characteristic of a data transaction that may be determined based on gesture speed may include, for example, priority of the data transaction relative to other data transactions already initiated (and still in progress) or subsequently initiated while the data transaction is still in progress, whether or not to encrypt a data file to be sent, and/or whether a copy of a sent data file is to be retained or not (e.g., copied versus moved). Other attributes of a gesture may additionally or alternatively be used to indicate the type of data transaction to be performed and/or one or more characteristics of the data transaction. For example, the number of fingers or other pointers used to make the gesture may be such an attribute. Where the touch screen is capable of multi-touch detection, the touch screen may be able to determine the positions of two or more simultaneous pointers on the touch screen. Thus, for example, a slide gesture with two adjacent (or co-located) fingers may be interpreted by the first computing device as a request the exchange of data be encrypted (or sent with a higher level of security), while a slide gesture with one finger may indicate the exchange of data at a normal security level. In yet another example, a continuous slide gesture (finger draws a continuous line or curve) may be interpreted by the first computing device as a request to copy a file (thereby keeping an instance of the file on the first computing device and creating a new instance of the file on the target computing device), whereas a broken slide gesture (finger is periodically lifted from the user interface 302) may be interpreted by the first computing device as a request to move the file (with deletion of the file on the first computing device after successful transmission to the target computing device). Therefore, the data transaction that is performed (and/or its characteristics) in response to a touch screen gesture may depend upon the number of fingers or other pointers used to perform the gesture. A gesture using one finger or other pointer may result in a first type of data transaction and/or a first characteristic of the data transaction, whereas the gesture using two fingers or other pointers may result in a different second type of data transaction and/or a different second characteristic of the data transaction. This functionality may be in addition to or as an alternative to the above-described speed-sensitive gesture detection.

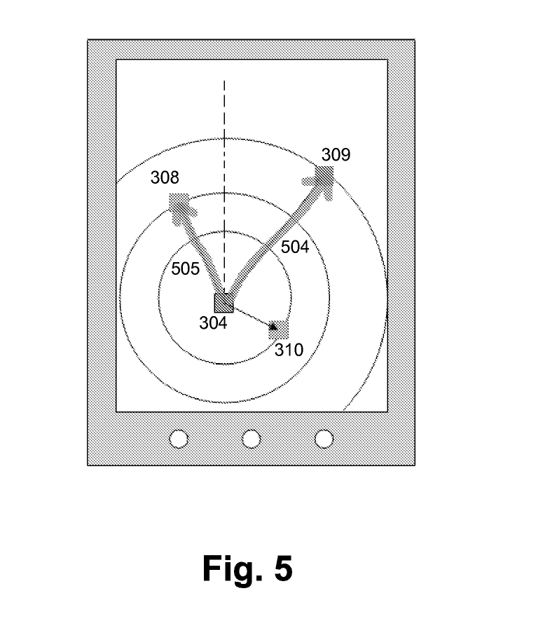

As another example as shown in FIG. 5, a user may perform data transactions between multiple computing devices at once. As in FIG. 4, a user may elect to perform a data transaction between the first computing device (icon 304) and the third computing device (icon 309). The user may also elect to perform a data transaction between the first computing device (icon 304) and the second computing device (icon 308). For example, the user may wish to copy a file, stream content, or send a communication, from the first computing device to both the second and third computing devices as part of the same data transaction or as part of two separate data transactions. To accomplish this, the user may, for example, drag his or her finger from icon 304 to icon 309, labeled in FIG. 5 as slide gesture 504, in order to perform a data transaction between the first and third computing devices. The user may then drag his or her finger from icon 304 to icon 308, labeled in FIG. 5 as slide gesture 505, in order to perform a data transaction (or extend the above data transaction to include a transaction) between the first and second computing devices. As in the description of FIG. 4, the relative speeds of the slide gestures may cause different types of data transactions to occur. For instance, the relative speeds of slide gestures 504 and 505 may give one of the data transactions (or portion of the single combined data transaction) priority over the other. Moreover, the relative speeds of the slide gestures may result in one data transaction (or portion thereof) to be granted more resources over the other. For example, even though the user may have performed slide gesture 504 before slide gesture 505, if slide gesture 505 is faster than slide gesture 504, the first computing device may pause (and/or allocate less resources to) the data transaction occurring between the first computing device and the third computing device and begin (and/or allocate more resources to) the indicated data transaction between the first computing device and the second computing device. Upon completion of the data transaction between the first computing device and the second computing device, the first computing device may resume the data transaction between the first computing device and the third computing device (or may allocate additional resources as available to that data transaction yet to be completed).

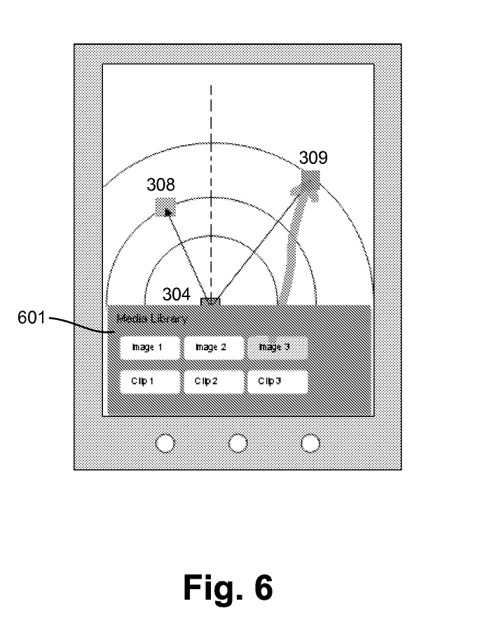

As shown in FIG. 6, a user may select one of the computing devices (an originating device) from which to transfer files. This may be the user's own computing device (in this example, the first computing device) or any others of the computing devices indicated by the user interface 302. For instance, the user may touch and hold one of the icons, which may cause the user interface 302 to display a media library 601 or other file selection portion of the user interface 302, which may indicate one or more data files and/or other data items stored at the selected originating device and available to be transferred. For instance, in the example of FIG. 6, the media library 601 shows six data items: Image 1, Image 2, Image 3, Clip 1, Clip 2, and Clip 3. The data items may also include folders that may contain further data items, such as in a hierarchical file storage system. The user may select one or more of the indicated data items for transfer (such as by tapping the one or more data items). In this example, assume that the user has selected the “Image 3” image file. The file(s) that has/have been selected for transfer may appear differently on the touch screen so as to indicate to the user that they have been selected. The user may then, for example, drag the selected data item(s) to the icon of a desired target computing device (or plural devices). In FIG. 6, the dragging gesture is shown to drag Image 3 to icon 309 (representing the third computing device). This may initiate the transfer of Image 3 from the originating device (in this example, the first computing device) to the target device (in this example, the third computing device).

The transfer of the data item may cause the target device to begin executing the appropriate software in order to present the data item (e.g., an image viewer if the data item is an image file, or a video player if the data item is a video clip) and/or to execute the item if the data item is an executable file.

Similarly to previous examples, the speed of the slide gesture from the selected data item (Image 3, in this example) to the target icon (icon 309, in this example) may determine the type of data transaction that is to occur between the selected computing devices, the properties of that data transaction, and/or which actions associated with the data transaction are to be performed. For example, a relatively slow slide gesture (e.g., slower than a predetermined threshold speed) may move (rather than copy) Image 3 from the first computing device to the third computing device. On the other hand, if the slide gesture is relatively faster (e.g., faster than a predetermined threshold speed) may cause Image 3 to be copied (rather than moved) to the target device. As another example, where the slide gesture is fast, this may cause the transfer of Image 3 to the target device as well as cause a command be sent to the target device that a photo viewer (or other appropriate software) be opened on the target device to present Image 3.

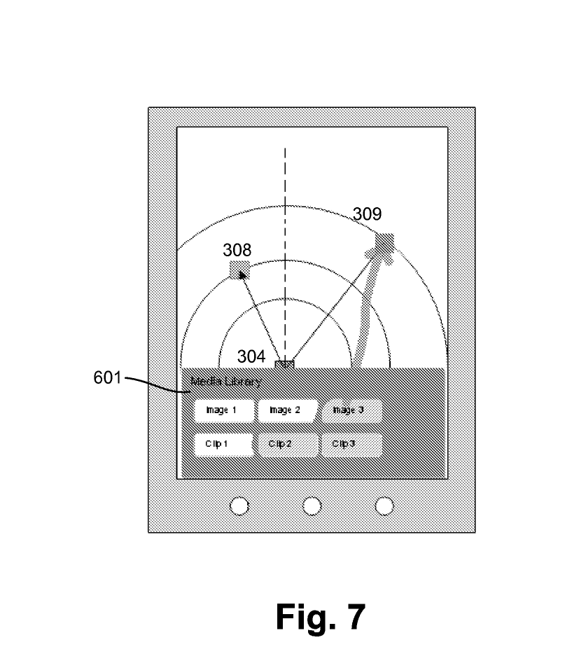

As shown in the example of FIG. 7, the user may select multiple files or other types of data items from a previously created folder in order to perform multiple simultaneous (parallel) data transactions between computing devices. For example, the user of the first computing device may select Image 3, Clip 2, and Clip 3 from the media library 601 of the first computing device in order to transfer those files to the third computing device (represented by icon 309). The user may select these data items by, for example, pressing on each representation of each file individually. As in the previous example, the data items marked for transfer may appear differently on the screen. In another example, the user may select multiple data items by dragging a finger or other pointer on the touch screen over or across the representations of the data items to be transferred. In still another example, the user may select the files to be transferred by dragging his or her finger or other pointer on the touch screen to encompass an area surrounding the representations of the data items to be transferred.

The user may transfer the data items from the originating device to the target device by, for instance, pressing a finger over one of the selected data items and dragging the group of data items to the icon of the target device, or by simply touching the icon of the target device. As discussed in the description of FIG. 5, the speed of the slide gesture here also may be used to determine what action to perform in response to the slide gesture. For instance, in the present example, in addition to the example data transactions described in the description of FIG. 5, a relatively fast slide gesture (e.g., faster than a predetermined threshold speed) may be interpreted by the first computing device as a user gesture requesting that the group of data items be compressed into a single file (e.g., a zip file or folder) to be sent to the target device. On the other hand, a relatively slow slide gesture (e.g., slower than a predetermined threshold speed) may be interpreted by the first computing device as a user input requesting that the group of data items be transferred without further compression to the target device.

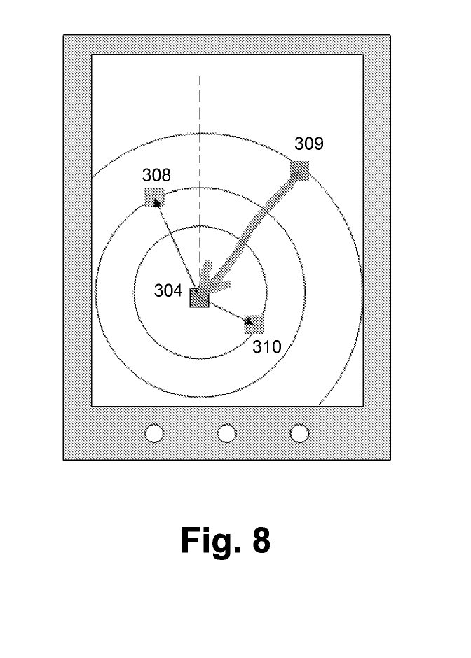

Some of the previously-discussed examples have illustrated data transactions that involve pushing information from one or more originating devices to one or more target devices. A user may additionally or alternatively elect to perform a data transaction involving pulling (or requesting) data from one or more computing devices. For example, as shown in FIG. 8, a data transaction may be invoked in which information is requested to be pulled from the third computing device (represented by icon 309) to the first computing device (represented by icon 304). The user may initiate the data transaction similarly to the example methods indicated in the description of FIG. 4. For instance, the user may press his or her finger or other pointer over the icon 309 of the third computing device in order to select the third computing device as the source of the data (the originating device). In response, the user interface may display one or more folders, files, and/or other data items that may be accessed from the third computing device similarly to the media library 601 of FIGS. 6 and 7. Additionally or alternatively, the first computing device may detect the user's wish to receive a data item in general, which may or may not be limited to a request for a data item from a specific originating device. The first computing device may then derive a list of available data from all available computing devices (or from a specified computing device) and display the available data items on the user interface 302. The user may then select the data he or she wishes to transfer from the third computing device to the first computing device in any manner similar to that described previously. For instance, the user may select one or more data items from the displayed media library 601 portion of the user interface 302 and then drag from the originating device icon (here, 309) to the destination device icon (here, 304), or the user may simply touch the destination device icon if the originating device (and/or the data item(s) to be transferred) has/have already been selected.

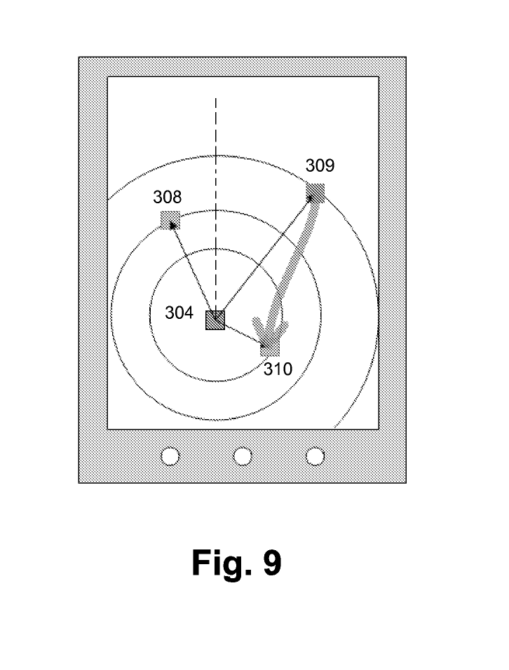

As shown in the example of FIG. 9, a user may elect to perform any data transaction between any two or more computing devices, even if those two or more computing devices do not include the first computing device (e.g., the computing device that is displaying the user interface 302). For example, a user operating the first computing device may elect to perform a data transaction (e.g., transfer a file, stream content, etc.) between the third computing device (represented by icon 309) and the fourth computing device (represented by icon 310).

Thus, in this example, the user of the first computing device (represented by icon 304) may initiate transfer of one or more data items from the third computing device to the fourth computing device by utilizing only the user interface 302 of the first computing device. In such an example, the user of the first computing device may view a list of available data items at the third computing device via the media library 601 portion of the user interface 302, such as in a manner as described in connection with FIGS. 6 and 7. The user of the first computing device may then select the data item(s) to be transferred, and by using his or her finger or other pointer, drag the representation(s) of the data item(s) from the icon 309 of the third computing device (or other originating device) to the icon 310 of the fourth computing device (or other target device).

As an example, the third computing device (or other originating device) may be equipped with some server capability and may store one or more data items (e.g., data files such as video clips, images, word processing documents, spreadsheets, drawings, PDFs, etc.), and the fourth computing device (or other target device) may be or otherwise include a display such as a television or computer monitor, which may be capable of displaying video media. The user of the first computing device, in this example, may use the user interface 302 as discussed above to transfer one or more media files from the third computing device (e.g., which may be configured as a media file server) to the television or monitor that is the fourth computing device, thereby potentially causing the media files to be displayed and played (e.g., streamed) by the television or monitor.

In this example, any or all of the computing devices represented by the user interface 302 may potentially be under the control of the user who is operating the first computing device. Therefore, no second user may be necessary to monitor and/or manually approve what data is sent from the third computing device to the fourth computing device (unless this is desired), and no third user may need to monitor and/or manually approve what data is received by the fourth computing device (unless this is desired).

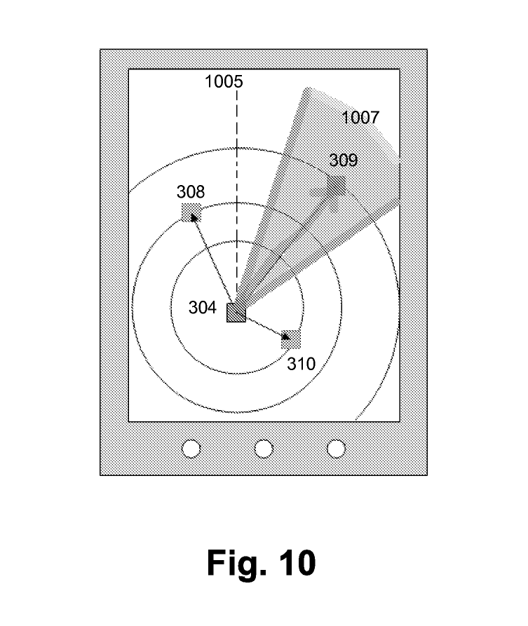

As another example described with reference to FIG. 10, the first computing device may detect a user input (e.g., a gesture touch input to the touch-sensitive display) indicating that the user wishes (or likely wishes) to transfer one or more data items from the first computing device to another computing device such as the third computing device. Either prior to receiving the user input, or in response to the initiation of the user input, the first computing device may determine and/or display a transfer region 1007 on the user interface 302. The transfer region 1007 may define an area of the user interface 302 that may continuously extend between the representation of the first computing device (or other originating device) and the representation of the third computing device (or other target device). The target device icon, here the icon 309 of the third computing device, may be specially identified (e.g., highlighted, shimmering, vibrating, enlarged, changing in color, etc.) as the intended target device as long as the user maintains his or her finger (or other pointer) within the boundary of the displayed transfer region 1007 during the slide gesture and/or in the direction of a line extending between the icon of the originating device and the icon of the target device.

The display of the transfer region 1007 may potentially provide the user more ease in transferring data to the correct target device in part because the user may not necessarily be required to drag his or her finger precisely from the icon of the originating device completely onto the icon of the target device. Rather, the user may simply drag substantially within the transfer region 1007.

The transfer region 1007 may be formed by, e.g., a radial section that encompasses a line extending between the transferring device and the expected target device icons. As another example, the transfer region may be by two angles measured from the dotted reference line, 1005.

By maintaining the slide gesture within the displayed transfer region 1007, the first computing device may be able to predict which is the target device (and may be able to indicate that prediction by displaying the transfer region 1007). If the slide gesture wanders outside the transfer region 1007, then the transfer region 1007 may no longer be displayed (and the prediction of the target device may no longer be valid) and/or another transfer region 1007 associated with another predicted target device may be displayed. For instance, if the slide gesture wanders downward toward icon 310, then the transfer region 1007 may disappear and/or another transfer region may appear extending between icon 304 and icon 310 (thus indicating that icon 310 represents the predicted target device).

If the user ends the slide gesture within a given displayed transfer region, then the first computing device may consider the slide gesture to represent a selection of the icon that is associated with the currently active transfer region (i.e., the transfer region in which the slide gesture ends). Another possibility is if the user input wanders outside of a transfer region, then the user interface 302 may no longer display any further transfer regions for that particular slide gesture, since the user input may not be as easily predicted or interpreted at this point unless and until the slide gesture ends at or near (e.g., at least within a predetermined threshold distance of) the icon of a particular target device. If no transfer region is displayed and the slide gesture does not end at or near a target device icon, then the user input may be considered aborted.

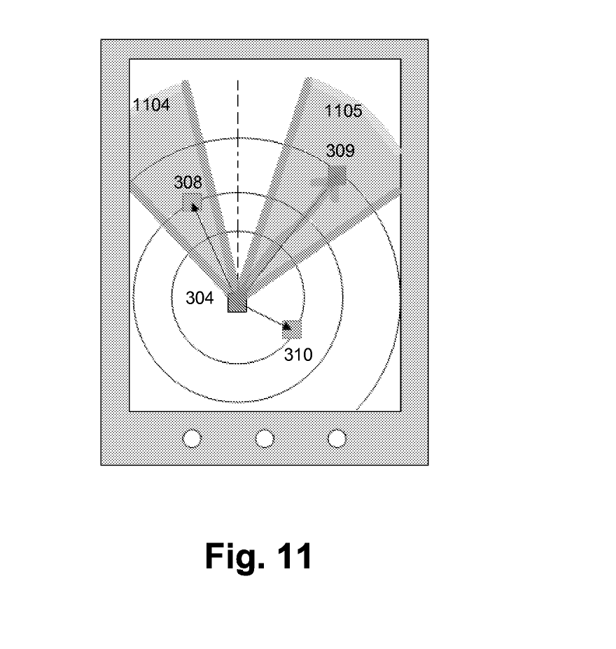

In another example described with reference to FIG. 11, the user interface 302 of the first computing device may simultaneously display multiple transfer regions, such as transfer regions 1104 and 1105. These multiple transfer regions may be of different colors, outlines, and/or shapes so as to distinguish them from one another. In the shown example, the first computing device may detect that the user may want to perform a data transaction between either the first computing device and the second computing device or the first computing device and the third computing device (or between an originating device and any other two or more predicted target devices). The first computing device may display the transfer region 1104 extending from the icon 304 of the first computing device (or other originating device) to the icon 308 of the second computing device (or other first predicted target device). The first computing device may simultaneously display the transfer region 1105 extending from the icon 304 of the first computing device (or other originating device) to the icon 309 of the third computing device (or other second predicted target device). In this example, if the user elects to transfer one or more data items between the first computing device and the second computing device, the user may drag his or her finger or other pointer within the transfer region 1104 generally in a direction similar to a line extending between icons 304 and 308. Similarly, if the user elects to transfer one or more data items between the first computing device and the third computing device, the user may drag his or her finger or other pointer within the transfer region 1105 generally in a direction similar to a line extending between icons 304 and 309.

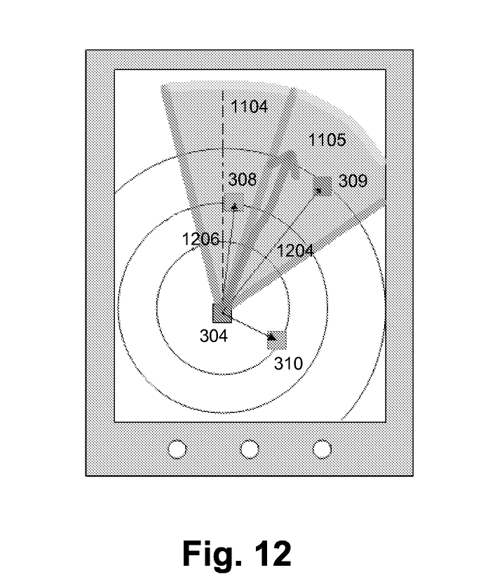

The first computing device intermittently may update, via the user interface 302, the locations of the various computing devices. Therefore, if, for instance, the distance between the second computing device and the third computing device shrinks, the transfer regions 1104 and 1105 may approach each other on the user interface 302. As two or more transfer regions approach each other, the transfer regions may, for example, dynamically shrink so as not to overlap with one another. Or, the transfer regions may simply be allowed to overlap each other as they approach one another, such as shown by way of example in FIG. 12.

As shown in FIG. 12, the transfer region 1104 overlaps with the transfer region 1105. In such an example, the first computing device may detect that the user wishes to transfer data from the first computing device to either the second computing device or to the third computing device (e.g., either to icon 308 or icon 309). To accomplish either data transaction, the user may initiate a slide gesture from a position in the desired transfer region at or near icon 304 towards either of the icons 308 or 309. If the user's slide gesture does not extend past the length of line 1204 (the radial distance extending from icon 304 to potential target icon 308), then the first computing device may interpret the input as a request to perform a data transaction between the first computing device and the second computing device (icon 308).

However, if the user's slide gesture extends past the length of line 1204, then the first computing device may interpret the input as a request to perform a data transaction between the first computing device and the third computing device (icon 309). Thus, the distance of the slide gesture may be used to distinguish between overlapping transfer regions. In still other examples, a slide gesture in the overlapping transfer region may cause the first computing device to perform parallel or serial data transactions both between the first computing device and the second computing device and between the first computing device and the third computing device.

Thus, various example systems, methods, and software have been described that may provide a tool for performing data transaction between multiple computing devices while only using a single computing device. While various examples have been illustrated and described, it is not intended that these examples illustrate and describe all possibilities. Rather, the words used in the specification are words of description rather than limitation, and it is understood that various changes may be made without departing from the spirit and scope of the present disclosure.

1. A method, comprising:
displaying, by a first computing device, a user interface;
receiving, by the first computing device, a first user input to the user interface;
determining, by the first computing device, a first data transaction depending upon a speed of the first user input; and
initiating, by the first computing device, the first data transaction,
wherein the user interface comprises a displayed representation of a second computing device, and the first data transaction is a data transaction between the first computing device and the second computing device,
if the speed of the first user input is less than a predetermined speed threshold, then said determining comprises determining that the first data transaction is a first type of data transaction; and
if the speed of the first user input is greater than the predetermined speed threshold, then said determining comprises determining that the first data transaction is a different second type of data transaction.

2. The method of claim 1, wherein the first user input is a slide gesture.

3. (canceled)

4. The method of claim 1, wherein the user interface further comprises a displayed representation of the first computing device, and the first user input comprises a slide gesture extending between the representations of the first and second computing devices.

5. The method of claim 1, wherein the user interface comprises a displayed representation of a second computing device and a displayed representation of a third computing device, and the data transaction is a data transaction between the second computing device and the third computing device.

6. The method of claim 5, wherein the first user input comprises a slide gesture extending between the representations of the second and third computing devices.

7. The method of claim 1, wherein said determining comprises determining the first data transaction depending also upon a number of pointers used to perform the first user input.

8. The method of claim 1, further comprising;
receiving, by the first computing device, a second user input to the user interface;
determining, by the first computing device, a speed of the second user input;
determining, by the first computing device a second data transaction based on the second user input; and
assigning relative priorities to the first and second data transactions depending upon the relative speeds of the first and second user inputs.

9. The method of claim 1, further comprising:
receiving, by the first computing device, a second user input to the user interface;
determining, by the first computing device, a speed of the second user input;
determining, by the first computing device a second data transaction based on the second user input; and
assigning resources to the first and second data transactions that depend upon the relative speeds of the first and second user inputs.

10. The method of claim 1, wherein the first user input is a slide gesture, and said determining further comprises determining the first data transaction depending also upon whether the slide gesture is a continuous slide gesture or a broken slide gesture.

11. The method of claim 1, wherein said determining comprises comparing the speed of the first user input with a predetermined speed threshold.

12. (canceled)

13. The method of claim 1, wherein the first type of data transaction is one of either moving a file or copying a file, and the second type of data transaction is the other of either moving a file or copying a file.

14. The method of claim 1, further comprising receiving information indicating physical locations of each of a plurality of computing devices, wherein said displaying comprises displaying, for each of the plurality of computing devices, a representation of the respective one of the plurality of computing devices at a location within the user interface that depends upon the physical location of the respective one of the plurality of computing devices.

15. The method of claim 14, wherein said displaying further comprises, for each of the plurality of computing devices, displaying the representation of the respective one of the plurality of computing devices only if the respective one of the computing devices has been authorized for communication with the first computing device.

16. A method, comprising:
displaying, by a first computing device, a user interface comprising representation of each of a plurality of computing devices;
displaying, by the first computing device, a first region of the user interface that continuously extends at least between a first location and a second location;
receiving, by the first computing device, a first user input comprising a first slide gesture that begins from either the first location or the second location; and
determining, by the first computing device, whether the first slide gesture remains within the first region, and initiating a data transaction involving the second computing device if the first slide gesture remains within the first region.

17. The method of claim 16, wherein the first region is a conical section.

18. The method of claim 16, wherein the representations comprise a first representation at the first location and a second representation at the second location each associated with a different one of the plurality of computing devices.

19. The method of claim 18, further comprising receiving information indicating physical locations of the plurality of computing devices, wherein said displaying comprises displaying the first and second representations at locations within the user interface that depend upon the physical locations of the respective associated one of the plurality of computing devices.

20. The method of claim 16, wherein said displaying comprises displaying a second region of the user interface that continuously extends at least between the first location and a third location.

21. The method of claim 20, further comprising decreasing a size of the first region responsive to the second region moving closer to the first region in the user interface.

22. The method of claim 20, wherein:
the second region overlaps the first region and a distance within the user interface between the first location and the second location is shorter than a distance between the first location and the third location; and
responsive to the first computing device receiving a second user input within an overlapping portion of the first and second regions that extends past the second location, performing a data transaction between the first computing device and the one of the computing devices associated with the third location.

23. The method of claim 20, wherein:
the second region overlaps the first region and a distance within the user interface between the first location and the second location is shorter than a distance between the first location and the third location; and
responsive to the first computing device receiving a second user input within an overlapping portion of the first and second regions that extends past the second location, performing a first data transaction between the first computing device and one of the computing devices associated with the third location and a second data transaction between the first computing device and one of the computing devices associated with the second location.

24. (canceled)

25. A method, comprising:
receiving, by a first computing device, an indication of a physical location of each of a plurality of computing devices at each of a sequence of times;
displaying, by the first computing device, a user interface comprising a representation of each of the plurality of computing devices, wherein for each of the plurality of computing devices and for each of the times, the representation of that computing device is displayed at a location of the user interface that depends upon the indicated physical location of that computing device;
receiving a user input selecting one of the representations; and
responsive to the user input, initiating a data transaction involving one of the computing devices associated with the selected representation,
wherein the user input comprises a gesture, and
wherein the data transaction type depends upon the at least one of the speed of the gesture, the direction of the gesture's movement, the number of fingers or other pointers used for the gesture, the position where the gesture movement begins and/or ends.

26. The method of claim 25, wherein each of the plurality of computing devices determines its own physical location and sends data representing the respective physical location to the first computing device.

27. The method of claim 25, wherein the distances between the representations of the computing devices are to scale relative to the distances between the computing devices.

28. The method of claim 25, wherein the first computing device and each of the plurality of computing devices are part of a same wireless piconet.

29. The method of claim 25, wherein the first computing device and each of the plurality of computing devices are part of a same cellular radio communication network.

30. The method of claim 25, wherein the user input is a slide gesture extending toward the selected representation.
